(19) United States
(12) Patent Application Publication
(10) Pub. No.: US 2025/0061015 A1
(43) Pub. Date: Feb. 20, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Maki TAGUCHI, Kanagawa (JP)

(73) Assignee: FUJIFILM Business Innovation Corp., Tokyo (JP)

(21) Appl. No.: 18/444,746

(22) Filed: Feb. 18, 2024

(30) Foreign Application Priority Data
Aug. 16, 2023 (JP) 2023-132470

(51) Int. Cl. G06F 11/07

(52) U.S. Cl. CPC G06F 11/0769; G06F 11/0733; G06F 11/079

(57) ABSTRACT

An information processing system includes a processor configured to: identify a log item that is related to a failure and that is included in a log item generated by an apparatus at occurrence of the failure; and perform reversible concealment on the identified log item and irreversible concealment on a log item that is other than the identified log item and that is included in the log item generated by the apparatus and output each log item having undergone a corresponding one of the reversible concealment and the irreversible concealment.

### CROSS-REFERENCE TO RELATED APPLICATIONS

This application is based on and claims priority under 35 USC 119 from Japanese Patent Application No. 2023-132470 filed Aug. 16, 2023.

### BACKGROUND

### (i) Technical Field

The present disclosure relates to an information processing system, a non-transitory computer readable medium, and an information processing method.

### (ii) Related Art

One of methods for investigating the cause of a failure of an apparatus is a method by which log information recorded in the apparatus is analyzed. The analysis is typically performed by the manufacturer of the apparatus or the maintenance service provider thereof. In contrast, log information regarding the apparatus sometimes includes personal information regarding a user of the apparatus or confidential information, such as a destination for transmission of a document. To protect the information regarding the user of the apparatus, the content of the information is concealed by hashing or encryption in extracting the log information from the apparatus. In addition, to observe the General Data Protection Regulation of the European Union, concealment is performed in extracting the log information from the apparatus.

In a case where hashing is used as the information concealment method, it is not possible to restore the original information from concealed data. Accordingly, the method by which all of pieces of log information in the apparatus are hashed in the extraction is perfect from the viewpoint of protection of apparatus user privacy but is not particularly usable for analyzing the cause of a failure.

In contrast, if encryption is used as the method for concealing log information, it is possible for a person in charge of analyzing the log information to restore the original log information by decrypting the encrypted log information and to thereby analyze the log information. However, if the values of all of the items of the log information extracted from the apparatus are encrypted to allow the person in charge of analyzing the log information to decrypt the values, the person in charge of the analysis knows even log items less related to the failure cause investigation. In addition, for the person in charge of the analysis, knowing the content of even the log items less related to the cause investigation leads to excessive responsibility from the viewpoint of customer secret protection.

As an example of a method for protecting secret information such as personal information, Japanese Unexamined Patent Application Publication No. 2004-259202 discloses a system in which information is encrypted in accordance with a condition set for classification of confidential information. Encryption ranks and encryption algorithms have been defined on the basis of the classification.

Japanese Unexamined Patent Application Publication No. 2006-189925 discloses a system in which when personal information data is stored, an attribute with a high protection level is hashed, an attribute with a medium level is encrypted, and an attribute with a low level is left as plain text.

### SUMMARY

However, the method in which the concealment method is changed in accordance with the level of the information is not suitable for the use for the log information extracted from the apparatus for failure cause investigation. This is because various types of failures occur on the apparatus, and a log item in the log information that is useful for the failure cause investigation depends on the failure type. Even if the concealment method for is changed on the basis of the level after the levels of the log items are classified in a uniform manner, the concealment method based on the level is not necessarily suitable for the type of the failure having occurred.

Aspects of non-limiting embodiments of the present disclosure relate to a system that enables a required log item appropriate for a failure to be restored.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: identify a log item that is related to a failure and that is included in a log item generated by an apparatus at occurrence of the failure; and perform reversible concealment on the identified log item and irreversible concealment on a log item that is other than the identified log item and that is included in the log item generated by the apparatus and output each log item having undergone a corresponding one of the reversible concealment and the irreversible concealment.

### BRIEF DESCRIPTION OF THE DRAWINGS

An exemplary embodiment of the present disclosure will be described in detail based on the following figures, wherein:

FIG. 1 is a view illustrating the system configuration of an image forming apparatus;

FIG. 2 is a view illustrating processing steps by a log acquisition program;

FIG. 3 is a view illustrating an example of an error detail input screen;

FIG. 4 is a view illustrating an example of an error/log-item table;

FIG. 5 is a view illustrating an example of a designation receiving screen;

FIG. 6 is a view illustrating the designation receiving screen in a state where some of checkboxes are checked;

FIG. 7 is a view illustrating an example of a confirmation screen;

FIG. 8 is a view for explaining concealed log information; and

FIG. 9 is a view illustrating an example of a designation receiving screen for designating log items for error codes that are not deletable.

### DETAILED DESCRIPTION

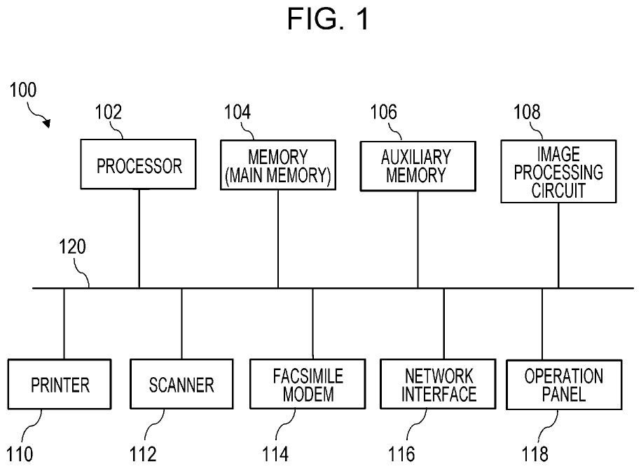

FIG. 1 illustrates an example of the hardware system configuration of an image forming apparatus 100 serving as an example of an information processing system.

The image forming apparatus 100 is a multifunction apparatus having functions of a printer, a scanner, a copier, and a facsimile and provides an advanced information processing function of a processor 102 built in the image forming apparatus 100. The image forming apparatus 100 includes hardware elements such as the processor 102, a memory 104, an auxiliary memory 106, an image processing circuit 108, a printer 110, a scanner 112, a facsimile modem 114, a network interface 116, an operation panel 118, and a bus 120.

The processor 102 is an arithmetic unit that runs programs and may include a central processing unit (CPU), a graphics processing unit (GPU), and the like. The processor 102 runs a group of control programs for the overall control of the image forming apparatus 100, programs for controlling the hardware elements, an application program using the functions of the hardware elements and the image forming apparatus 100 as a whole, and the like. The control program group of the image forming apparatus 100 includes a program for receiving a signal reporting the occurrence of an error from the components of the image forming apparatus 100 and for executing a process for the error. The program causes the operation of the image forming apparatus 100 to be controlled for the error having occurred and information regarding the error to be displayed on a user interface (UI) screen displayed on the display on the operation panel 118 of the image forming apparatus 100. The control program group also includes a program for recording log data regarding operations performed by the image forming apparatus 100, events that are predetermined as a matter and that have occurred on the image forming apparatus 100, errors having occurred on the image forming apparatus 100, and the like. The control program group also includes a log acquisition program for acquiring recorded log data from the storage place and outputting to the outside.

The memory 104 is a main memory where a work memory area is provided when the processor 102 runs a program and is configured as, for example, a random access memory. The auxiliary memory 106 is a large capacity storage where the programs run by the processor 102 and data to be used for the programs or data to be stored after being generated by the programs are stored in a nonvolatile manner. For example, a hard disk drive or a solid state drive is used as the auxiliary memory 106. The log data described above is stored, for example, in the auxiliary memory 106.

The image processing circuit 108 is a circuit for performing various image processing on an image such as an image read by the scanner 112 or an image to be printed by the printer 110. The printer 110 is an apparats that prints an image on the sheet. The scanner 112 is an apparatus that optically reads an image of a paper document or the like and converts the image into electronic image data. The facsimile modem 114 is connected to a telephone line and is used for image communication conforming to a facsimile standard via the telephone line. The network interface 116 is used to perform control communication with a network such as a local area network. The operation panel 118 is a system for receiving operation input to the image forming apparatus 100 from a user and includes a display such as a touch panel.

The devices described above such as the processor 102 to the operation panel 118 are mutually connected via a data transmission path such as the bus 120.

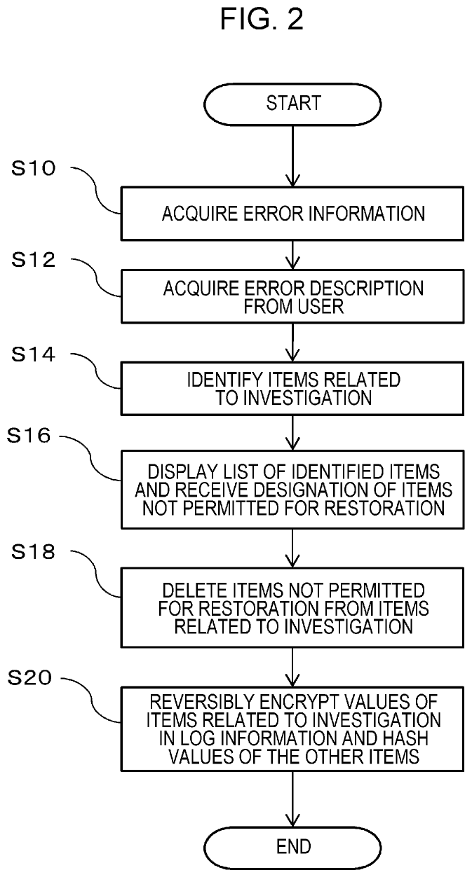

The flow of a process executed when the processor 102 runs the log acquisition program will then be described with reference to FIG. 2. In this example, if the control program of the image forming apparatus 100 detects the occurrence of an error, the log acquisition program is run.

In this case, the processor 102 acquires information regarding the error having occurred from the control program (S10). The error information to be acquired at this time includes an error code. The error code is a code uniquely assigned to a type of an error (that is, a failure) having occurred on the image forming apparatus 100. The processor 102 also displays, on the display of the operation panel 118, a screen for receiving input of a description of the error by the user and acquires the description input by the user on the screen (S12).

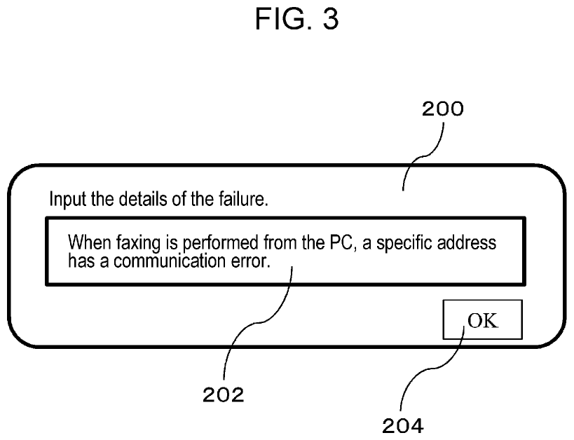

FIG. 3 illustrates an example of an error detail input screen 200 serving as a UI screen displayed in step S12. On the error detail input screen 200, the message “Input the details of the failure.”, an input field 202 for receiving input of the description from the user, and an OK button 204 are displayed. In response to seeing the message, the user inputs the description of the details of the error in the input field 202 by using a keyboard or the like on the operation panel 118. The description indicates, for example, the state at the time of the error occurrence or what operation causes the error (that is, the failure).

The processor 102 then identifies log items related to the investigation for this time error on the basis of the error code acquired in step S10 and the user's description acquired in step S12 (S14). The log information recorded by the image forming apparatus 100 includes various log items not required for the error cause investigation and log items with investigation need levels from a low level to a considerably high level. Hence, in step S14, among the various log items, log items with high levels to some extent regarding the need for the investigation of the cause of the error having occurred this time are identified.

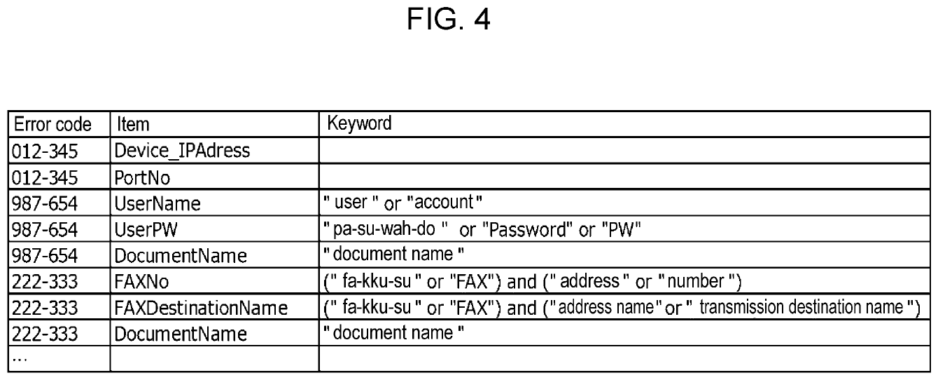

To identify the log items, the image forming apparatus 100 uses an error/log-item table. FIG. 4 illustrates an example of the error/log-item table. In the illustrated table, the identification names of respective log items required for the investigation of the causes of errors each indicated by a corresponding one of error codes are registered in the Item fields in association with the error code. As understood from this example, there is a case where multiple log items associated with one error code are listed as required items.

In addition, in the Keyword fields of the table, keywords highly related to the log items are registered. Some log items do not have a keyword registered therefor, and some log items have two or more keywords registered therefor. If a keyword in one of the Keyword fields is included in the error details description input by the user, it is determined that the log item corresponding to the Keyword field is an item with a high level to some extent regarding the need for the investigation of the cause of the error having occurred this time. In this case, in step S14, the log item is identified as a log item related to the investigation of this time error.

In addition, in the example in FIG. 4, a logical expression for a keyword is registrable in each Keyword field. For example, in the Keyword field corresponding to the log item “UserName”, the logical OR between “user” and “account” is registered, like “user” or “account”. In this case, if the description includes at least one of the character string “user” or the character string “account”, the log item “UserName” therefor is identified in step S14 as the log item related to the investigation of this time error. In addition, for example, in the Keyword field corresponding to the log item “FAXDestinationName”, the logical expression”(“fa-kku-su” or “FAX”) and (“address name” or “transmission destination name”)” is registered, the term “fa-kku-su” meaning fax in Japanese. In this case, if the description includes at least one of the character string “fax” or the character string “FAX” and also includes at least one of the character string “address name” or the character string “transmission destination name”, the log item “FAXDestinationName” is identified in step S14 as the log item related to the investigation of this time error.

In this example, the level of association of each log item (in other words, a need level) regarding this time error investigation may also be found. In a merely example, the association levels may be classified into three levels of High, Medium, and Low, and a log item with a Medium or High association level may be identified in step S14 as the log item related to the investigation of this time error.

At this time, for example, the association level of a log item associated with the error code acquired in step S10 is determined as High.

If the description input by the user includes a character string that perfectly matches a keyword registered in the table described above in association with a log item, the association level of the log item may be determined as High. If the description includes wording that does not perfectly match a keyword registered in association with a log item but that applies to a synonym of the keyword, the association level of the log item may be determined as Medium. The synonym of the keyword may be determined by look up in a thesaurus stored in the auxiliary memory 106 or the like. If a logical expression in a Keyword field corresponding to the log item in the table described above is perfectly satisfied, the association level of the log item may be determined as High. If combination of character strings in the description satisfies a logical expression after one or more of character strings in the logical expression are converted to a synonym thereof, the association level of the log item may be determined as Medium. The association level of a log item that does not apply to any of High and Medium may be determined as Low.

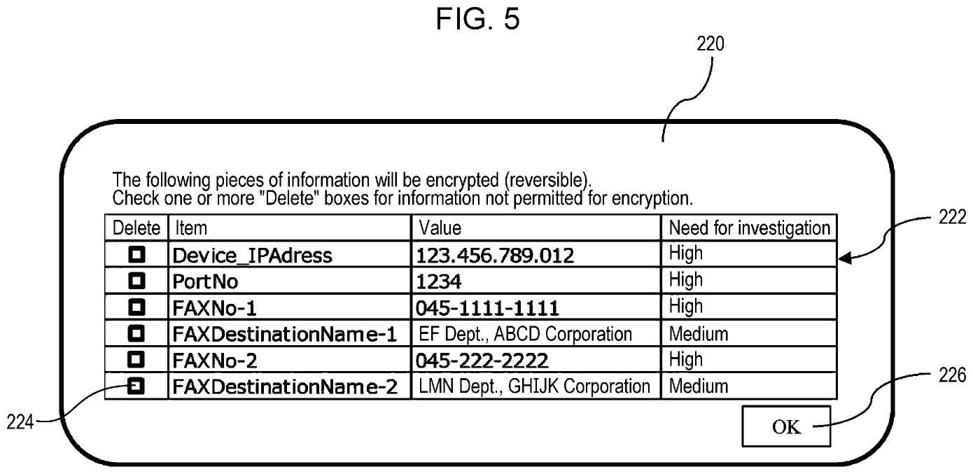

Referring back to the explanation with reference to FIG. 2, after step S14, the processor 102 displays, on the display of the operation panel 118, a screen indicating a list of log items each identified as the log item related to the investigation of this time error, and receives, from the user, the designation of log items that are included in the log items and that are not permitted for restoration (S16). FIG. 5 illustrates an example of a designation receiving screen 220 displayed on the display by the processor 102 in step S16.

On the designation receiving screen 220 illustrated in FIG. 5, the message “The following pieces of information will be encrypted (reversible). Check one or more “Delete” boxes for information not permitted for encryption.”, a table 222, and an OK button 226 are displayed. Rows in the table 222 correspond to the respective log items identified as the log items related to the investigation in step S14. Each row in the table 222 is composed of four fields that are Delete, Item, Value, and Need for investigation.

The Delete fields include checkboxes 224 capable of turning on and off. The initial state (that is, a state at the time point when the designation receiving screen 220 including the table 222 has been displayed for the first time) of each checkbox 224 of a corresponding one of the log items is an off state. FIG. 5 illustrates the initial state, and the checkbox 224 is represented in the off state, that is, an outlined square on the screen. If the checkbox 224 is in the off state, the value of the log item is subjected to predetermined reversible encryption.

The overall picture of the log information concealment performed using the log acquisition program of this exemplary embodiment is described. The log acquisition program causes the value of a log item included in the log information in the image forming apparatus 100 to be concealed when the log information is extracted to the outside. The concealment method includes hashing and encryption, and one of these is used for each log item. The encryption for the log item is a reversible process. For the encrypted value, the original value may be restored by decryption. In contrast, hashing is an irreversible process, and thus it is not possible to restore the original value from the hashed value. In this exemplary embodiment, the concealment of the value of each log item identified in step S14 as the log item related to the investigation of this time error is performed with encryption by default. However, this embodiment is designed to enable the user to designate, by using the designation receiving screen 220, one or more of the identified log items the values of which are not permitted for restoration. The value of each log item for which the non-permission of the restoration is designated is concealed by hashing.

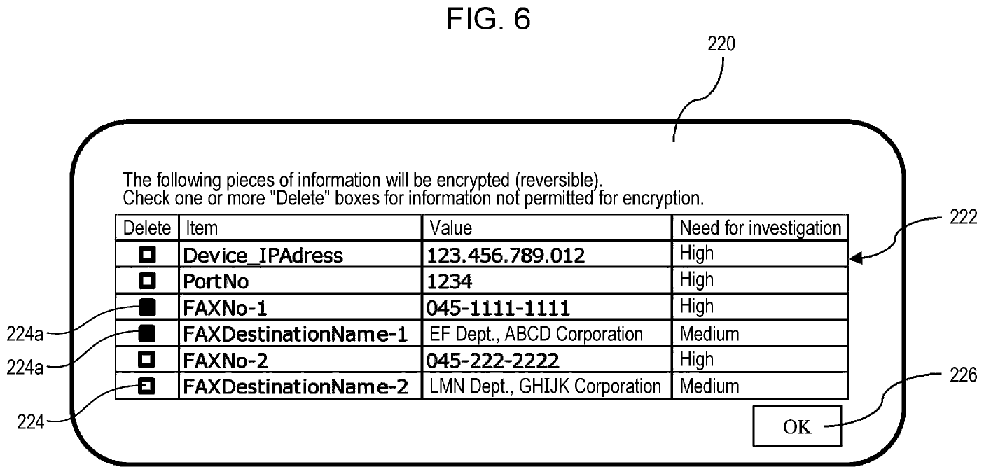

If the user does not permit the reversible encryption when the value of a log item is output to the outside, the user changes the state of an intended one of the checkboxes 224 to an on state (in a black filled state in FIG. 6) through a touch operation. The state of the checkbox 224 toggles between the on state and the off state in response to being touched.

In each Value field in the table 222, the value of a log item in the log information generated by the control program in response to the detection of this time error is set. For example, if the log information regarding this time error includes the log item “Device_IPAdress”, and if a value in the log item is “123.456.789.012”, a record is set as in the first row in the table 222 in FIG. 5.

In the Need for investigation field, the association level of the log item that is the need level of the value of the log item regarding the error cause investigation is set, the need level being determined in step S14.

In the example in FIG. 5, the log items “Device_IPAdress” and “PortNo” in the first and second rows are identified from the error codes acquired in step S10, and the values of the Need for investigation fields are set High. In contrast, the log items in the third to sixth rows are identified from the description by the user acquired in step S12, and the value of the association level found in step S14 is set in the corresponding Need for investigation field.

In response to seeing the designation receiving screen 220 illustrated in FIG. 5, the user verifies whether the log items listed in the table 222 include a log item with the concealed values intended not to permit the restoration thereof (in other words, a log item with a value intended not to be known to a person outside the organization). If there is a log item not permitted for restoration, the user touches the checkbox 224 of the log item of the table 222 to turn on the checkbox 224 (that is, to be filled in with black). FIG. 6 illustrates a state where checkboxes 224a and 224b for the third and fourth log items from the top in the table 222 in FIG. 5. In response to the completion of the selection of the log items not permitted for restoration, the user presses the OK button 226.

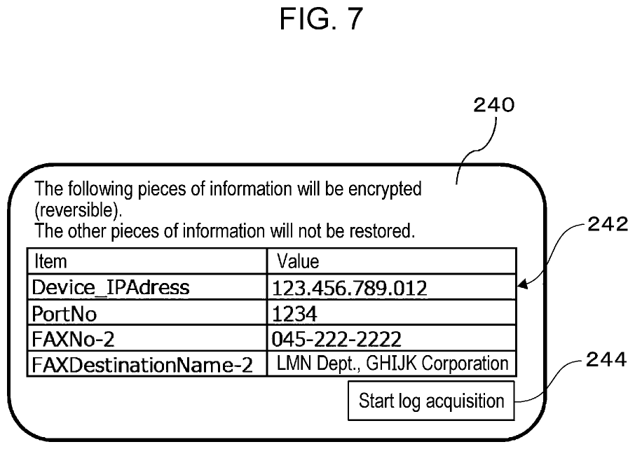

In response to the pressing the OK button 226, the processor 102 deletes the log items corresponding to the checkboxes 224 in the on state from the list of the log items related to the investigation (S18). That is, the log items related to the investigation previously identified by performing step S14 are listed in the table 222, and one or more of the log items each corresponding to the checkbox 224 in the on state are deleted. The processor 102 then displays a confirmation screen 240 illustrated in FIG. 7 on the display of the operation panel 118. On the confirmation screen 240, the message “The following pieces of information will be encrypted (reversible). The other pieces of information will not be restored” and a table 242 having log items related to the investigation that are left without being deleted are displayed. The user looks at the table 242 on the confirmation screen 240 for the final check. If there is no problem, the user presses a button 244. The value of each log item listed in the table 242 is decided as a target for the reversible encryption.

If an operation for changing the state of the checkbox 224 from the off state to the on state is performed in step S16, the processor 102 may display a screen for displaying a warning message on the display. The displayed message indicates that, for example, the change adversely affects the error cause investigation. The message may indicate that the higher level in the Need for investigation filed a log item has, the more adversely the error cause investigation are affected.

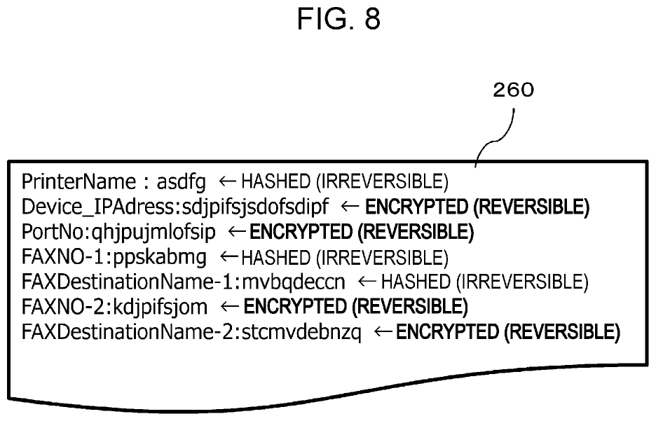

Referring back to the explanation with reference to FIG. 2, after step S18, the processor 102 performs a concealment step on the value of each log item in the log information regarding this time error. The processor 102 thus performs the predetermined reversible encryption on the values of the log items related to the investigation left after the deletion step in step S18 in the log information regarding this time error and performs hashing on the values of the other log items (S20). The processor 102 outputs the log information with the values of the log items concealed in this manner. FIG. 8 illustrates an example of data resulting from the concealment step (S20). The example is based on the content of the display of the confirmation screen 240 in FIG. 7, and the reversible encryption is performed on the values of the four log items.

The output log information after the concealment is transmitted to, for example, a maintenance contractor who contracts to maintain the image forming apparatus 100. In this case, the maintenance contractor tries to decrypt the values of the log items in the log information and analyzes the cause of the error by using semantic values of log items decryption of which succeeds.

As described above, according to this exemplary embodiment, among items in the log information regarding an error, items related to error cause investigation undergo the reversible encryption wherever practical.

In the example above, designation for deleting all the log items related to the investigation identified in step S14 (that is, not permitted for restoration) is received from the user. However, this is merely an example.

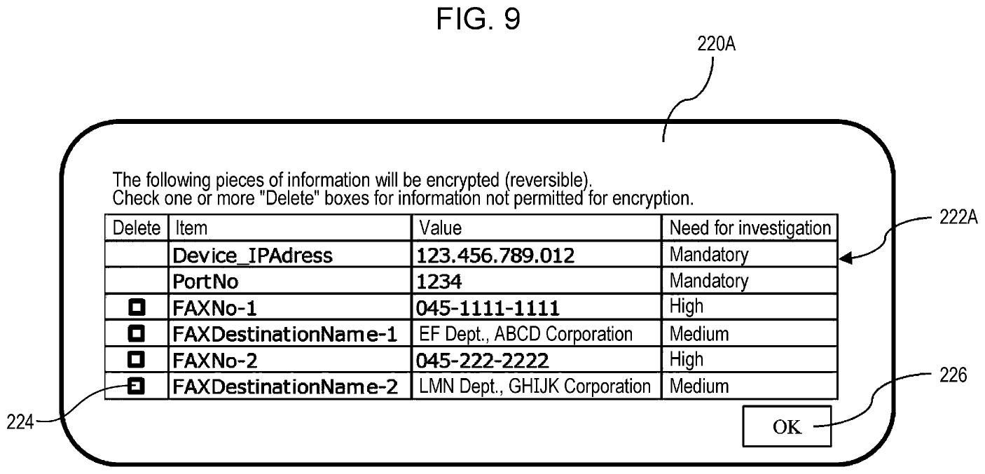

In another example, for example, log items identified on the basis of the error code of an error having occurred may be targets for the reversible encryption any time to prevent the user from deleting this from the targets. FIG. 9 illustrates a designation receiving screen 220A displayed in step S16 in FIG. 2 in this example. In the Delete fields of a table 222A on the designation receiving screen 220A, the checkboxes 224 are displayed for the four third to sixth log items from the top that are identified from the description input by the user. However, for the first and second log items identified from the error code, the checkboxes 224 are not displayed. These two log items each have the value “Mandatory” in the Need for investigation fields. In this example, the log items registered in the error/log-item table (FIG. 4) in association with the error codes are regarded as being necessarily required for the error cause investigation and are designed to be necessarily restored.

In the example above, a log item associated with a keyword included in the description input by the user is regarded as a log item related to an error and thus is to be subjected to reversible encryption, but this is merely an example. Instead of the keyword-based method as described above, for example, machine learning may be used. In a machine-learning-based method, for example, a large number of pieces of training data as combinations of a description of the details of an error in the natural language and log items related to the investigation of the cause of the error are prepared. A computer is then trained to become capable of outputting log items related to the cause investigation from the input descriptions. Parameters indicating the feature of the computer trained in this manner are stored, for example, in the auxiliary memory 106 of the image forming apparatus 100. When performing step S14 in FIG. 2 by running the log acquisition program, the processor 102 uses the parameters to identify the log items from the description. That is, the processor 102 builds up a pre-trained model by using the parameters and inputs therein the description acquired from the user in step S12. In response to the input, the model outputs some log items as the log items related to the error cause investigation. If information regarding the association level of the log item related to the error cause investigation is included in the training data, the computer may be trained to output the log item related to the error cause investigation and the association level thereof from the input description.

In the example above, the processor 102 of the image forming apparatus 100 runs the log acquisition program. However, in another example, a computer terminal connected to the image forming apparatus 100 by a person in charge of maintenance for maintenance work may run the log acquisition program.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass onc processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system includes:
a processor configured to:
   identify a log item that is related to a failure and that is included in a log item generated by an apparatus at occurrence of the failure; and
   perform reversible concealment on the identified log item and irreversible concealment on a log item that is other than the identified log item and that is included in the log item generated by the apparatus and output each log item having undergone a corresponding one of the reversible concealment and the irreversible concealment.
      (((2)))

In the information processing system according to (((1))),
the processor is configured to:
   acquire a code that indicates a type of the failure and that is issued by the apparatus at the occurrence of the failure; and
   find a log item associated with the acquired code with reference to correspondence information indicating correspondence between the code indicating the type of the failure and a log item required to analyze the failure of the type, and identify the found log item as the log item related to the failure.
      (((3)))

In the information processing system according to (((2))),
the processor is configured to:
   execute a process for displaying a screen for receiving input of a description of a detail of the failure from a user at the occurrence of the failure; and
   find a log item related to the input description and identify the found log item as the log item related to the failure.
      (((4)))

In the information processing system according to (((3))),
the processor is configured to:
   receive, from the user, designation of whether the reversible concealment is to be permitted for the log item identified as the log item related to the input description, the identified log item being included in the log item identified as the log item related to the failure; and
   perform irreversible concealment on a log item for which designation not permitting the reversible concealment is received from the user, the log item being included in the log item identified as the log item related to the failure.
      (((5)))

In the information processing system according to (((4))),
the processor is configured to:
   present, to the user, information regarding a level of association between the log item identified as the log item related to the input description and the description and receive, from the user, the designation of whether the reversible concealment is to be permitted for the identified log item, the identified log item being included in the log item identified as the log item related to the failure.
      (((6)))

In the information processing system according to (((1))),
the processor is configured to:
   execute a process for displaying a screen for receiving input of a description of a detail of the failure at the occurrence of the failure; and
   find a log item related to the input description and identify the found log item as the log item related to the failure.
      (((7)))

In the information processing system according to (((1))),
the processor is configured to:
   present the log item identified as the log item related to the failure to a user and receive, from the user, designation of whether the reversible concealment is to be permitted for the presented log item; and
   perform irreversible concealment on a log item for which designation not permitting the reversible concealment is received from the user, the log item being included in the log item identified as the log item related to the failure.
      (((8)))

In the information processing system according to (((7))),
the processor is configured to:
   identify, as the log item related to the failure, a log item associated with a code that indicates a type of the failure and that is issued by the apparatus at the occurrence of the failure or a log item related to a description of a detail of the failure, the description being input by the user at the occurrence of the failure; and
   in presenting the log item identified as the log item related to the failure, present, to the user, a need level of the identified log item in failure investigation together with the log item identified as the log item related to the failure, and
the need level is found on a basis of at least one of whether the log item is found as the log item associated with the code, whether the log item is found as the log item related to the description, or a level of association of the log item with the description.
   (((9)))

A program causes a computer to execute a process including:
identifying a log item that is related to a failure and that is included in a log item generated by an apparatus at occurrence of the failure; and
performing reversible concealment on the identified log item and irreversible concealment on a log item that is other than the identified log item and that is included in the log item generated by the apparatus and outputting each log item having undergone a corresponding one of the reversible concealment and the irreversible concealment.

What is claimed is:

1. An information processing system comprising:
a processor configured to:
identify a log item that is related to a failure and that is included in a log item generated by an apparatus at occurrence of the failure; and
perform reversible concealment on the identified log item and irreversible concealment on a log item that is other than the identified log item and that is included in the log item generated by the apparatus and output each log item having undergone a corresponding one of the reversible concealment and the irreversible concealment.

2. The information processing system according to claim 1,
wherein the processor is configured to:
acquire a code that indicates a type of the failure and that is issued by the apparatus at the occurrence of the failure; and
find a log item associated with the acquired code with reference to correspondence information indicating correspondence between the code indicating the type of the failure and a log item required to analyze the failure of the type, and identify the found log item as the log item related to the failure.

3. The information processing system according to claim 2,
wherein the processor is configured to:
execute a process for displaying a screen for receiving input of a description of a detail of the failure from a user at the occurrence of the failure; and
find a log item related to the input description and identify the found log item as the log item related to the failure.

4. The information processing system according to claim 3,
wherein the processor is configured to:
receive, from the user, designation of whether the reversible concealment is to be permitted for the log item identified as the log item related to the input description, the identified log item being included in the log item identified as the log item related to the failure; and
perform irreversible concealment on a log item for which designation not permitting the reversible concealment is received from the user, the log item being included in the log item identified as the log item related to the failure.

5. The information processing system according to claim 4,
wherein the processor is configured to:
present, to the user, information regarding a level of association between the log item identified as the log item related to the input description and the description and receive, from the user, the designation of whether the reversible concealment is to be permitted for the identified log item, the identified log item being included in the log item identified as the log item related to the failure.

6. The information processing system according to claim 1,
wherein the processor is configured to:
execute a process for displaying a screen for receiving input of a description of a detail of the failure at the occurrence of the failure; and
find a log item related to the input description and identify the found log item as the log item related to the failure.

7. The information processing system according to claim 1,
wherein the processor is configured to:
present the log item identified as the log item related to the failure to a user and receive, from the user, designation of whether the reversible concealment is to be permitted for the presented log item; and
perform irreversible concealment on a log item for which designation not permitting the reversible concealment is received from the user, the log item being included in the log item identified as the log item related to the failure.

8. The information processing system according to claim 7,
wherein the processor is configured to:
identify, as the log item related to the failure, a log item associated with a code that indicates a type of the failure and that is issued by the apparatus at the occurrence of the failure or a log item related to a description of a detail of the failure, the description being input by the user at the occurrence of the failure; and
in presenting the log item identified as the log item related to the failure, present, to the user, a need level of the identified log item in failure investigation together with the log item identified as the log item related to the failure, and
wherein the need level is found on a basis of at least one of whether the log item is found as the log item associated with the code, whether the log item is found as the log item related to the description, or a level of association of the log item with the description.

9. A non-transitory computer readable medium storing a program causing a computer to execute a process comprising:
identifying a log item that is related to a failure and that is included in a log item generated by an apparatus at occurrence of the failure; and
performing reversible concealment on the identified log item and irreversible concealment on a log item that is other than the identified log item and that is included in the log item generated by the apparatus and outputting each log item having undergone a corresponding one of the reversible concealment and the irreversible concealment.

10. An information processing method comprising:
identifying a log item that is related to a failure and that is included in a log item generated by an apparatus at occurrence of the failure; and
performing reversible concealment on the identified log item and irreversible concealment on a log item that is other than the identified log item and that is included in the log item generated by the apparatus and outputting each log item having undergone a corresponding one of the reversible concealment and the irreversible concealment.
